(19) United States
(12) Patent Application Publication
(10) Pub. No.: US 2005/0201591 A1
(43) Pub. Date: Sep. 15, 2005

(54) Method and apparatus for recognizing the position of an occupant in a vehicle

(76) Inventor: Stephen J. Kiselewich, Carmel, IN (US)

Correspondence Address: STEFAN V. CHMIELEWSKI;DELPHI TECHNOLOGIES, INC., Legal Staff MC CT10C, P.O. Box 9005, Kokomo, IN, 46904-9005, US

(21) Appl. No.: 10/797,411

(22) Filed: Mar. 10, 2004

(51) Int. Cl. G06K 9/00; G06K 9/62

(52) U.S. Cl. 382/104; 382/154; 382/224

(57) ABSTRACT

A method of object detection includes receiving images of an area occupied by at least one object. Image features including wavelet features are extracted from the images. Classification is performed on the image features as a group in at least one common classification algorithm to produce object class confidence data.

### TECHNICAL BACKGROUND

The present invention relates to techniques for processing sensor data for object classification. More specifically, the present invention relates to the control of vehicle systems, such as air bag deployment systems, based on the classification of vehicle occupants.

### BACKGROUND OF THE INVENTION

Virtually all modern passenger vehicles have air bag deployment systems. The earliest versions of air bag deployment systems provided only front seat driver-side air bag deployment, but later versions included front seat passenger-side deployment. Current deployment systems provide side air bag deployment. Future air bag deployment systems will also include protection for passengers in rear seats. Today's air bag deployment systems are generally triggered whenever there is a significant vehicle impact, and will activate even if the area to be protected is unoccupied or is occupied by someone unlikely to be protected by the air bag.

While thousands of lives have been saved by air bags, a number of people have been injured and a few have been killed by the deploying air bag. Many of these injuries and deaths have been caused by the vehicle occupant being too close to the air bag when it deploys. Children and small adults have been particularly susceptible to injuries from air bags. Also, an infant in a rear-facing infant seat placed on the right front passenger seat is in serious danger of injury if the passenger airbag deploys. The United States Government has recognized this danger and has mandated that car companies provide their customers with the ability to disable the passenger side air bag. Of course, when the air bag is disabled, passengers, including full size adults, are provided with no air bag protection on the passenger side.

Therefore, a need exists for detecting the presence of a vehicle occupant within an area protected by an air bag. Additionally, if an occupant is present, the nature of the occupant must be determined so that air bag deployment can be fashioned so as to eliminate or minimize injury to the occupant.

Various mechanisms have been disclosed for occupant sensing. Breed et al. in U.S. Pat. No. 5,845,000, issued Dec. 1, 1998, describe a system to identify, locate, and monitor occupants in the passenger compartment of a motor vehicle. The system uses electromagnetic sensors to detect and image vehicle occupants. Breed et al. suggest that a trainable pattern recognition technology be used to process the image data to classify the occupants of a vehicle and make decisions as to the deployment of air bags. Breed et al. describe training the pattern recognition system with over one thousand experiments before the system is sufficiently trained to recognize various vehicle occupant states. The system also appears to rely solely upon recognition of static patterns. Such a system, even after training, may be subject to the confusions that can occur between certain occupant types and positions because the richness of the occupant representation is limited. It may produce ambiguous results, for example, when the occupant moves his hand toward the instrument panel.

A sensor fusion approach for vehicle occupancy is disclosed by Corrado, et al. in U.S. Pat. No. 6,026,340, issued Feb. 15, 2000. In Corrado, data from various sensors is combined in a microprocessor to produce a vehicle occupancy state output. Corrado discloses an embodiment where passive thermal signature data and active acoustic distance data are combined and processed to determine various vehicle occupancy states and to determine whether an air bag should be deployed. The system disclosed by Corrado detects and processes motion data as part of its sensor processing, thus providing additional data upon which air bag deployment decisions can be based. However, Corrado discloses multiple sensors to capture the entire passenger volume for the collection of vehicle occupancy data, increasing the complexity and decreasing the reliability of the system. Also, the resolution of the sensors at infrared and ultrasonic frequencies is limited, which increases the possibility that the system may incorrectly detect an occupancy state or require additional time to make an air bag deployment decision.

Another sensor fusion approach for vehicle occupancy is disclosed by Owechko, et al. in U.S. Patent Application Publication No. US 2003/0204384, which is incorporated herein by reference. In Owechko, three different features, including a disparity map, a wavelet transform, and an edge detection and density map, are extracted from images captured by image sensors. Each of these three features is individually processed by respective classification algorithms to produce class confidences for various occupant types. The occupant class confidences are fused and processed to determine occupant type. A problem is that each of the three classification algorithms produces its class confidences based on only its respective feature. Since each classification algorithm has the benefit of only information associated with its respective feature, and does not have the benefit of information associated with the other two of the three features, the accuracy of the class confidences produced by the classification algorithms may not be as accurate as they could possibly be.

Accordingly, there exists a need in the art for a fast and highly reliable system for detection and recognizing occupants in vehicles for use in conjunction with vehicle air bag deployment systems. There is also a need for a system that can meet the aforementioned requirements with a sensor system that is a cost-effective component of the vehicle.

### SUMMARY OF THE INVENTION

In one embodiment of the present invention, an apparatus for object detection is presented. The apparatus comprises a computer system including a processor, a memory coupled with the processor, an input for receiving images coupled with the processor, and an output for outputting information based on an object estimation coupled with the processor. The computer system further comprises means, residing in its processor and memory, for receiving images of an area occupied by at least one object; extracting image features including wavelet features from the images; and performing classification on the image features as a group in at least one common classification algorithm to produce object class confidence data.

In another embodiment, the at least one classification algorithm is selected from the group consisting of a Feedforward Backpropagation Neural Network, a trained C5 decision tree, a trained Nonlinear Discriminant Analysis network, and a trained Fuzzy Aggregation Network.

In a further embodiment of the present invention, the means for extracting image features comprises a means for extracting wavelet coefficients of the at least one object in the images. Further, the means for classifying the image features comprises processing the wavelet coefficients with at least one common classification algorithm to produce object class confidence data.

In another embodiment, the object comprises a vehicle occupant and the area comprises a vehicle occupancy area, and the apparatus further comprises a means for providing signals to vehicle systems, such as signals that comprise airbag enable and disable signals.

In a still further embodiment, the apparatus comprises a means for capturing images from a sensor selected from a group consisting of CMOS vision sensors and CCD vision sensors.

In yet another embodiment, the means for extracting image features further comprises means for detecting edges of the at least one object within the images; masking the edges with a background mask to find important edges; calculating edge pixels from the important edges; and producing edge density maps from the important edges, the edge density map providing the image features, and wherein the means for classifying the image features processes the edge density map with at least one classification algorithm to produce object class confidence data.

In a yet further embodiment, the means for extracting image features further comprises means for receiving a stereoscopic pair of images of an area occupied by at least one object; detecting pattern regions and non-pattern regions within each of the pair of images using a texture filter; generating an initial estimate of spatial disparities between the pattern regions within each of the pair of images; using the initial estimate to generate a subsequent estimate of the spatial disparities between the non-pattern regions based on the spatial disparities between the pattern regions using disparity (order and smoothness) constraints; iteratively using the subsequent estimate as the initial estimate in the means for using the initial estimate to generate a subsequent estimate in order to generate further subsequent estimates of the spatial disparities between the non-pattern regions based on the spatial disparities between the pattern regions using the disparity constraints until there is no change between the results of subsequent iterations, thereby generating a final estimate of the spatial disparities; and generating a disparity map of the area occupied by at least one object from the final estimate of the spatial disparities, and wherein the means for classifying the image features processes the disparity map with the at least one classification algorithm to produce object class confidence data.

In still another embodiment, the apparatus further comprises means for detecting motion of the at least one object within the images; calculating motion pixels from the motion; and producing motion density maps from the motion pixels, the motion density map providing the image features; and the means for classifying the image features processes the motion density map with the at least one classification algorithms to produce object class confidence data.

The features of the above embodiments may be combined in many ways to produce a great variety of specific embodiments, as will be appreciated by those skilled in the art. Furthermore, the means which comprise the apparatus are analogous to the means present in computer program product embodiments and to the steps in the method embodiment.

### BRIEF DESCRIPTION OF THE DRAWINGS

The objects, features and advantages of the present invention will be apparent from the following detailed descriptions of embodiments of the invention in conjunction with reference to the following drawings.

FIG. 1 is a block diagram depicting the components of a computer system used in the present invention;

FIG. 2 is an illustrative diagram of a computer program product embodying the present invention;

FIG. 3 is a block diagram for the first embodiment of the object detection and tracking system provided by the present invention;

FIG. 4 is a block diagram depicting the general steps involved in the operation of the present invention;

FIG. 5 is a flowchart depicting the steps required to derive occupant features from image edges;

FIG. 6 depicts a representative mask image for the front passenger side seat;

FIG. 7 depicts a few examples of the resulting edge density map for different occupants and car seat positions;

FIG. 8 is a block diagram depicting the components (steps) of the disparity map module;

FIG. 9 depicts a neighborhood density map created during the disparity estimation step, whose entries specify the number of points in an 8-connected neighborhood where a disparity estimate is available;

FIG. 10 depicts an example of allowed and prohibited orders of appearance of image elements;

FIG. 11 depicts an example of a 3×3 neighborhood where the disparity of the central element has to be estimated;

FIG. 12 depicts an example of a stereo image pair corresponding to the disparity map depicted in FIG. 13;

FIG. 13 depicts the disparity map corresponding to the stereo image pair shown in FIG. 12, with the disparity map computed at several iteration levels;

FIG. 14 is an illustrative example of an actual occupant with a disparity grid superimposed for facilitating an accurate selection of the points used to estimate the disparity profile;

FIG. 15 depicts several examples of disparity maps obtained for different types of occupants; and

FIG. 16 is a block diagram for another embodiment of the object detection and tracking system provided by the present invention.

### DESCRIPTION OF INVENTION

The present invention relates to techniques for processing sensor data for object classification. More specifically, the present invention relates to the control of vehicle systems, such as air bag deployment systems, based on the classification of vehicle occupants. The following description, taken in conjunction with the referenced drawings, is presented to enable one of ordinary skill in the art to make and use the invention and to incorporate it in the context of particular applications. Various modifications, as well as a variety of uses in different applications, will be readily apparent to those skilled in the art, and the general principles defined herein, may be applied to a wide range of embodiments. Thus, the present invention is not intended to be limited to the embodiments presented, but is to be accorded the widest scope consistent with the principles and novel features disclosed herein. Furthermore it should be noted that unless explicitly stated otherwise, the figures included herein are illustrated diagrammatically and without any specific scale, as they are provided as qualitative illustrations of the concept of the present invention.

In order to provide a working frame of reference, first a glossary of terms used in the description and claims is given as a central resource for the reader. Next, a discussion of various physical embodiments of the present invention is provided. Finally, a discussion is provided to give an understanding of the specific details.

(1) Glossary

Before describing the specific details of the present invention, a centralized location is provided in which various terms used herein and in the claims are defined. The glossary provided is intended to provide the reader with a feel for the intended meaning of the terms, but is not intended to convey the entire scope of each term. Rather, the glossary is intended to supplement the rest of the specification in more accurately explaining the terms used.

Means: The term “means” as used with respect to this invention generally indicates a set of operations to be performed on a computer, and may represent pieces of a whole program or individual, separable, software modules. Non-limiting examples of “means” include computer program code (source or object code) and “hard-coded” electronics (i.e. computer operations coded into a computer chip). The “means” may be stored in the memory of a computer or on a computer readable medium.

Object: The term object as used herein is generally intended to indicate a physical object for which classification is desired.

Sensor: The term sensor as used herein generally includes a detection device, possibly an imaging sensor or optical sensors such as CCD. cameras. Non-limiting examples of other sensors that may be used include radar and ultrasonic sensors.

(2) Physical Embodiments

The present invention has three principal “physical” embodiments. The first is a system for determining operator distraction, typically in the form of a computer system operating software or in the form of a “hard-coded” instruction set. This system may be incorporated into various, devices such as a vehicular warning system, and may be coupled With a variety of sensors that provide information regarding an operator's distraction level. The second physical embodiment is a method, typically in the form of software, operated using a data processing system (computer). The third principal physical embodiment is a computer program product. The computer program product generally represents computer readable code stored on a computer readable medium such as an optical storage device, e.g., a compact disc (CD) or digital versatile disc (DVD), or a magnetic storage device such as a floppy disk or magnetic tape. Other, non-limiting examples of computer readable media include hard disks, read only memory (ROM), and flash-type memories. These embodiments will be described in more detail below.

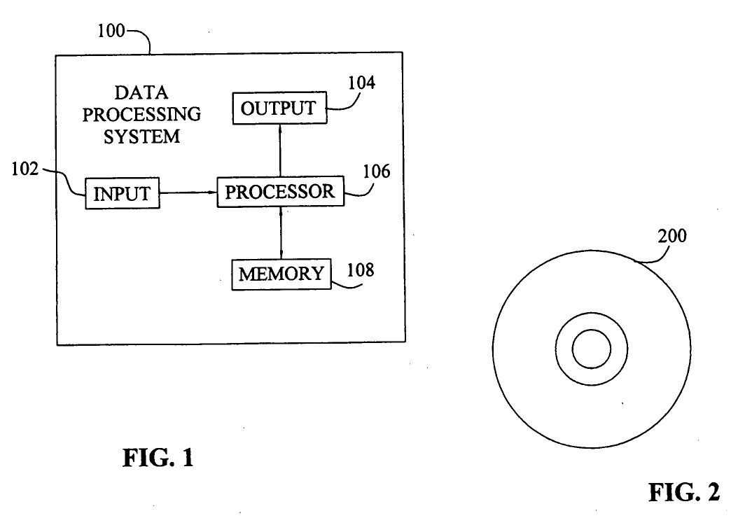

A block diagram depicting the components of a computer system used in the present invention is provided in FIG. 1. The data processing system 100 comprises an input 102 for receiving information from at least one sensor for use in classifying objects in an area. Note that the input 102 may include multiple “ports”. Typically, input is received from sensors embedded in the area surrounding an operator such as CMOS and CCD vision sensors. The output 104 is connected with the processor for providing information regarding the object(s) to other systems in order to augment their actions to take into account the nature of the object (e.g., to vary the response of an airbag deployment system based on the type of occupant). Output may also be provided to other devices or other programs, e.g. to other software modules, for use therein. The input 102 and the output 104 are both coupled with a processor 106, which may be a general-purpose computer processor or a specialized processor designed specifically for use with the present invention. The processor 106 is coupled with a memory 108 to permit storage of data and software to be manipulated by commands to the processor.

An illustrative diagram of a computer program product embodying the present invention is depicted in FIG. 2. The computer program product 200 is depicted as an optical disk such as a CD or DVD. However, as mentioned previously, the computer program product generally represents computer readable code stored on any compatible computer readable medium.

(3) Introduction

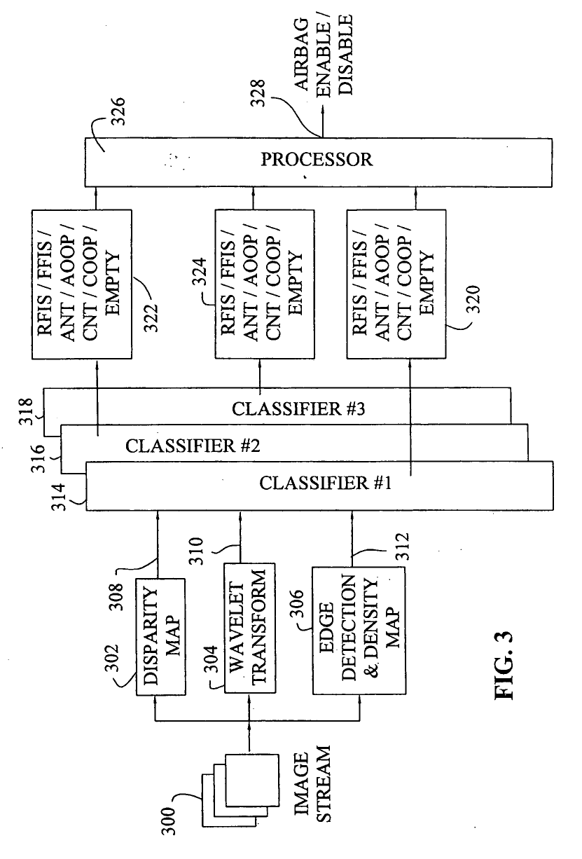

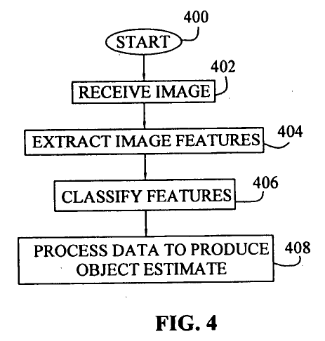

A block diagram of a first embodiment of the object detection and tracking system provided by the present invention is shown in FIG. 3. In general, the present invention extracts different types of information or features from the stream of images 300 generated by one or more vision sensors. It is important to note, however, that although vision sensors such as CCD and CMOS cameras may be used, other sensors such as radar and ultrasonic sensors may also be used. Feature extraction modules 302, 304, and 306 receive and process frames from the stream of images 300 to provide feature data 308, 310, and 312. Each of feature data 308, 310, and 312 is input into a common classification algorithm stored in a common classifier module 314. The common classification algorithm performs classification on feature data 308, 310, and 312 as a group.

It is possible to provide additional common classifier modules 316, 318 having respective classification algorithms. Each of classifier modules 316, 318 can also receive each of feature data 308, 310, 312. Classifier modules 314, 316, 318 can be substantially identical, with the exception that the classification algorithm of each module can have at least one different parameter value. In one embodiment, these different parameter values can be the result of different initial states or starting values used in the programming of classifier modules 314, 316, 318, as discussed in more detail below. These different initial states or starting values can be random, i.e., can established randomly, or can be established with some element of randomness.

It is to be understood that additional classifier modules 316, 318 are not necessary for the operation of the present invention, but may provide some additional benefit as discussed below. It is within the scope of the present invention to provide only a single classifier module 314. It is also within the scope of the present invention to provide some number of additional classifier modules other than two. That is, instead of the two additional classifier modules 316, 318 shown in the embodiment of FIG. 3, it is possible to provide any other number of additional classifier modules, such as 0, 1, 3, 10, etc. Each additional classifier module may provide some incremental benefit that may be weighed against the incremental cost of the additional classifier module for a particular application of the present invention.

Each classifier module 314, 316, and 318 classifies the occupant. into one of a small number of classes, such as adult in normal position or rear-facing infant seat. Each classifier generates a class prediction and confidence value 320, 322, and 324. Since the classification algorithm of each classifier module 314, 316, 318 has at least one different parameter value, as mentioned above, class prediction and confidence values 320, 322, 324 produced thereby can all be slightly different. Because each of class prediction and confidence values 320, 322, 324 is based upon each of feature data 308, 310, 312, each of class prediction and confidence values 320, 322, 324 can be more accurate than a class prediction and confidence value that is based upon feature data 308 alone, feature data 310 alone, or feature data 312 alone. That is, each of class prediction and confidence values 320, 322, 324 can be more accurate because it is based on more information. The parameter values of the classification algorithms of classifier modules 314, 316, 318 can be learned through the use of back propagation techniques known in the art.

The predictions and confidences of the classifiers are then input or fed into a processor 326 which makes the final decision to enable or disable the airbag, represented by an enable/disable signal 328. Processor 326 can process the class prediction and confidence values 320, 322, 324 by performing a mathematical function on values 320, 322, 324. The enable/disable signal 328 can depend on the output of this mathematical function. For example, processor 326 can mathematically average values 320, 322, 324 and produce an enable/disable signal 328 based upon that average. Because processor 326 bases the enable/disable signal 328 on each of values 320, 322, 324, the enable/disable signal 328 can be more accurate than an enable/disable signal that is based on one of values 320, 322, 324 alone. That is, the enable/disable signal 328 can be more accurate because it is based upon more information.

Use of vision sensors in one embodiment of the present invention permits an image stream 300 from a single set of sensors to be processed in various ways by a variety of feature extraction modules in order to extract many different features therefrom. For reasons of low cost, flexibility, compactness, ruggedness, and performance, a CCD or CMOS imaging chip may be used as the imaging sensor. CMOS vision chips, in particular, have many advantages for this application and are being widely developed for other applications. A wide variety of CMOS and CCD vision sensors may be used in the various embodiments. The FUGA Model 15d from Fill Factory Image Sensors and Mitsubishi's CMOS Imaging Sensor chip are two examples of imaging sensor chips that may be used in the various embodiments of the present invention. The FUGA chip provides a logarithmic response that is particularly useful in the present invention. The LARS II CMOS vision sensor from Silicon Vision may also be used, especially since it provides pixel-by-pixel adaptive dynamic range capability. The vision sensors may be used in conjunction with an active illumination system in order to ensure that the area of occupancy is adequately illuminated independently of ambient lighting conditions.

As shown in FIG. 3, the feature extraction modules produce different types of features utilized in the exemplary embodiment. A Disparity Map module 302 produces disparity data 308 obtained by using two vision sensors in a triangulation mode. A Wavelet Transform module 304 provides scale data 310 in the form of wavelet coefficients. An Edge Detection and Density Map module 306 produces an edge density map 312. These modules 302, 304, and 306 can be implemented by separate hardware processing modules executing the software required to implement the specific functions, or a single hardware processing unit can be used to execute the software required for all these functions. Application specific integrated circuits (ASICs) may also be used to implement the required processing.

Next, the feature data 308, 310, and 312 are provided to classifier modules and tracking modules 314, 316, and 318. In the embodiment as shown in FIG. 3, three classifier modules are used. All three of the classifier modules produce classification values for rear-facing infant seat (RFIS), front-facing infant seat (FFIS), adult in normal or twisted position (ANT), adult out-of-position (AOOP), child in normal or twisted position (CNT), child out-of-position (COOP),and empty; each of classifiers 314, 316, 318 processing the disparity data 308 from the Disparity Map module 302, the scale data 310 from the Wavelet Transform module 304, and the edge density map data 312 from the Edge Detection and Density Map module 306. All of the classifiers have low computational complexity and have high update rates. The details of the feature extraction modules and the classifiers are described below.

In the exemplary embodiment of the present invention, one or more vision sensors are positioned on or around the rear-view mirror, or on an overhead console. Positioning the vision sensors in these areas allows positions of both the driver and front seat passenger or passengers to be viewed. Additional vision sensors may be used to view passengers in other areas of the car such as rear seats or to particularly focus on a specific passenger area or compartment. The vision sensors are fitted with appropriate optical lens known in the art to direct the appropriate portions of the viewed scene onto the sensor.

A flow chart depicting the general steps involved in the method of the present invention is shown in FIG. 4. After the start of the method 400, a step of receiving images 402 is performed in which a series of images is input into hardware operating the present invention. Next, various features, including features such as those derived from a disparity map, a wavelet transform, and via edge detection and density are extracted 404. Once the features have been extracted, the features are classified 406 and the resulting classifications are then processed to produce an object estimate 408. These steps may also be interpreted as means or modules of the apparatus of the present invention, and are discussed in more detail below.

(4) Wavelet Transform

In an occupant sensing system for automotive applications one of the key events is represented by a change in the seat occupant. A reliable system to detect such occurrence will thus provide some additional amount of information to be exploited to establish the occupant type. If it is known with some degree of accuracy, in fact, that no major changes have occurred in the observed scene, such information can be provided to the system classification algorithm as an additional parameter. This knowledge can then be used, for example, to decide whether a more detailed analysis of the scene is required (in the case where a variation has been detected) or, on the contrary, some sort of stability in the occupant characteristics has been reached (in the opposite case) and minor variations should be just related to noise. The Wavelet Transform module 304 implements the processing necessary to detect an occupant change event.

The wavelet-based approach used in the Wavelet Transformation module 304 is capable of learning a set of relevant features for a class based on an example set of images. The relevant features may be used to train a classifier that can accurately predict the class of an object. To account for high spatial resolution and to efficiently capture global structure, an over-complete/redundant wavelet basis may be used.

In one embodiment, an over-complete dictionary of Haar wavelets are used that respond to local intensity differences at several orientations and scales. A set of labeled training data from the various occupant classes is used to learn an implicit model for each of the classes. The occupant images used for training are transformed from image space to wavelet space and are then used to train a classifier.

It is possible to add noise to the occupant images training data such that the level of noise in the training data approximates the level of noise that will likely be in the image stream obtained during operation. As mentioned above, each of classifier modules 314, 316, 318 can have different initial states or starting values at the beginning of the training. These initial states or starting values can be established randomly. By virtue of the different initial states or starting values, the classification algorithms within classifier modules 314, 316, 318 can all have slightly different parameter values at the end of the training. Thus, although classifier modules 314, 316, 318 can all receive the same inputs from disparity map 302, wavelet transform 304 and edge detection and density map 306, the outputs of classifier modules 314, 316, 318, i.e., class prediction and confidence values 320, 322, 324, can all be different.

For a given image, the wavelet transform computes the response of the wavelet filters over the image. Each of three oriented wavelets—vertical, horizontal, and diagonal, are computed at different scales—possibly 64×64 and 32×32. The multi-scale approach allows the system to represent coarse as well as fine scale features. The over-complete representation corresponds to a redundant basis wavelet representation and provides better spatial resolution. This is accomplished by shifting wavelet templates by ¼ the size of the template instead of shifting the size of the template. The absolute value of the wavelet coefficients may be used, thus eliminating the differences in features when considering situations involving a dark object on a white background and vice-versa.

The speed advantage resulting from the wavelet transform may be appreciated by a practical example where 192×192 sized images were extracted from a camera image and down sampled to generate 96×96 images. Two wavelets of size 64×64 and 32×32 were then used to obtain a 180-dimensional vector that included vertical and horizontal coefficients at the two scales. The time required to operate the wavelet transform classifier, including the time required for extracting the wavelet features by the Wavelet Transform module 304, was about 20 ms on an Intel Pentium III processor operating at 800 MHz, and optimized using SIMD and MMX instructions.

(5) Edge Detection and Density Map

In the exemplary embodiment of the present invention, the Edge Detection and Density Map module 306 provides data to classifier modules 314, 316, 318, which then calculate class confidences based, in part, on image edges. Edges have the important property of being relatively insusceptible to illumination changes. Furthermore, with the advent of CMOS sensors, edge features can be computed readily by the sensor itself. A novel and simple approach is used to derive occupant features from the edge map.

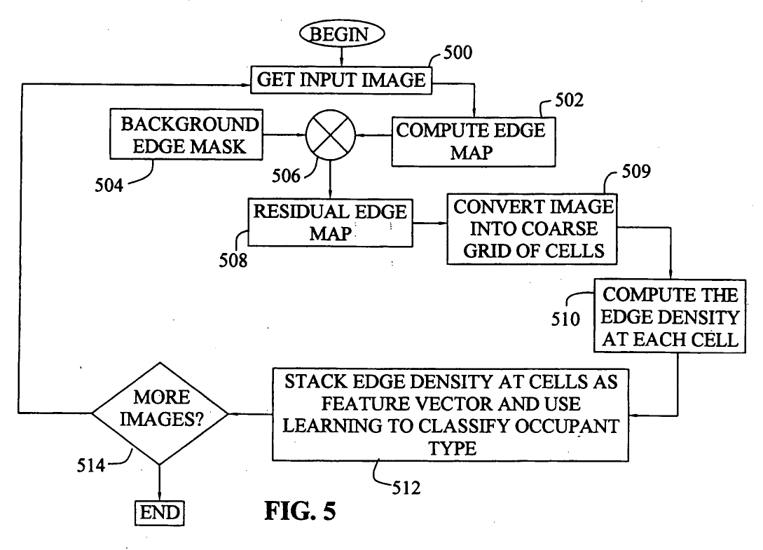

The flowchart shown in FIG. 5 shows the steps required to derive occupant features from image edges. Block 500 represents the acquisition of a new input image. Block 502 represents the computation of an edge map for this image. As indicated above, CMOS sensors known in the art can provide this edge map as part of their detection of an image.

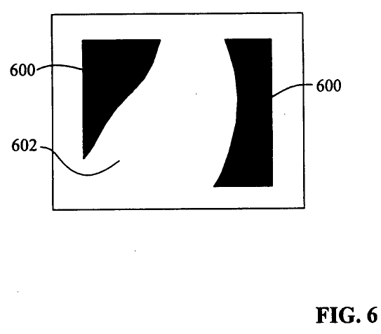

Block 504 represents the creation of a background mask image. This mask image is created to identify pixels in the image that are important. FIG. 6 shows a representative mask image for the front passenger side seat. In FIG. 6, the unimportant edges are marked by areas 600 shown in black while the important edges are marked by areas 602 shown in white.

Operation 506 represents the masking of the edge map with the mask image to identify the important edge pixels from the input image. Block 508 represents the creation of the residual edge map. The residual edge map is obtained by subtracting unimportant edges (i.e., edges that appear in areas where there is little or no activity as far as the occupant is concerned).

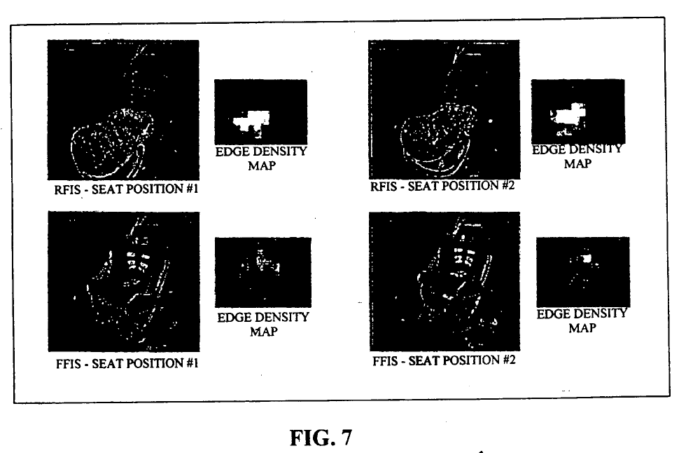

The residual edge map can then be used to determine specific image features. Block 509 represents the conversion of the residual image map into a coarse cell array. Block 510 represents the computation of the density of edges in each of the cells in the coarse array using the full resolution residual edge map. The edge density in coarse pixel array is then normalized based on the area covered by the edges in the residual edge map by the coarse pixel. A few examples of the resulting edge density map are shown in FIG. 7 for different occupants and car seat positions. Notice that the edge density map for RFIS (rear-facing infant seat) at two different car seat positions are more similar in comparison to the edge density maps for the FFIS (front-facing infant seat) at the same car seat positions.

Block 512 represents the extraction of features (e.g., 96 for a 12×8 array) from the coarse pixel array. The edge densities of each cell in the edge density map are stacked as features. The features are provided by a feature vector formed from the normalized strength of edge density in each cell of the coarse cell array. The feature vector is then used by classification algorithms (such as the FBNN, C5, NDA and FAN algorithms discussed below) to classify the occupant into RFIS, FFIS, Adult in normal position, Adult out-of-position, Child in normal position, or Child out-of-position. Block 514 represents the iteration of the algorithm for additional images according to the update rate in use.

In the exemplary embodiment of the present invention, a standard fully-interconnected, feedforward backpropagation neural network (FBNN) may be used as the classification algorithms.

(6) Disparity Map

(a) Introduction and System Description

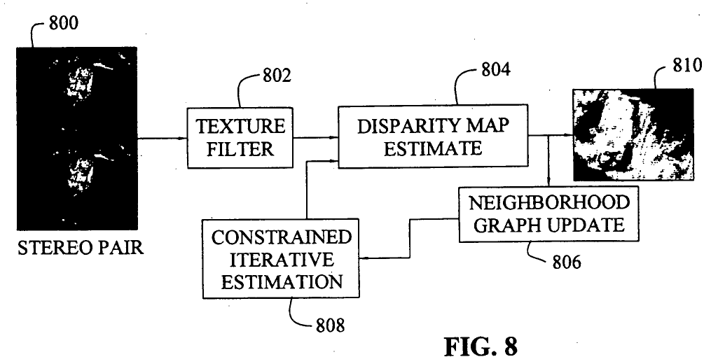

The disparity estimation procedure used in the Disparity Map module 302 is based on image disparity. The procedure used by the present invention provides a very fast time-response, and may be configured to compute a dense disparity map (more than 300 points) on an arbitrary grid at a rate of 50 frames per second. The components of the Disparity Map module 302 are depicted in FIG. 8. A stereo pair of images 800 is received from a stereo camera, and is provided as input to a texture filter 802. The task of the texture filter 802 is to identify those regions of the images characterized by the presence of recognizable features, and which are thus suitable for estimating disparities. An initial disparity map is estimated from the output of the texture filter 802 by a disparity map estimator 804. Once the disparity of the points belonging to this initial set has been estimated, the computation of the disparity values for the remaining points is carried on iteratively as a constrained estimation problem. In order to do so, first a neighborhood graph update is performed 806, and a constrained iterative estimation 808 is performed. In this process, denser neighborhoods are examined first and the disparity values of adjacent points are used to bound the search interval. Using this approach, smooth disparity maps are guaranteed and large errors due to matching of poorly textured regions are highly reduced. As this iterative process progresses, a disparity map 810 is generated, and can be used for object classification. In simpler terms, the Disparity Map Module 302 receives two images from different locations. Based on the differences in the images a disparity map is generated, representing a coarse estimate of the surface variations or patterns present in area of the images. The surface variations or patterns are then classified in order to determine a likely type of object to which they belong. Note that if the range to one pixel is known, the disparity map can also be used to generate a coarse range map. More detail regarding the operation of the Disparity Map Module 302 is provided below.

Several choices are available for the selection of a texture filter 802 for recognizing regions of the image characterized by salient features, and the present invention may use any of them as suited for a particular embodiment. In one embodiment, a simple texture filter 802 was used for estimating the mean variance of the rows of a selected region of interest. This choice reflects the necessity of identifying those image blocks that present a large enough contrast along the direction of the disparity search. For a particular N×M region of the image, the following quantity:

$${σ}^{2} = \frac{1}{M ( N - 1 )} {\sum }_{y = 0}^{M - 1} {\sum }_{x = 0}^{N - 1} {( I ( x , y ) - \frac{1}{N} {\sum }_{x = 0}^{N - 1} I ( x , y ) )}^{2} \qquad ( 1 )$$

is compared against a threshold defining the minimum variance considered sufficient to identify a salient image feature. Once the whole image has been filtered and the regions rich in texture have been identified, the disparity values of the selected regions are estimated minimizing the following cost function in order to perform the matching between the left and right image:

$${d}^{( opt )} = {min}_{d} {\sum }_{y = 0}^{M - 1} {\sum }_{x = 0}^{N - 1} \vert {I}_{left} ( x + d , y ) - {I}_{right} ( x , y ) \vert . \qquad ( 2 )$$

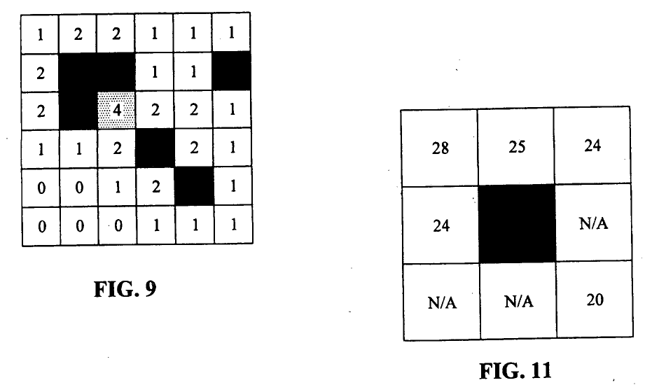

During the disparity estimation step, a neighborhood density map is created. This structure consists of a matrix of the same size as the disparity map, whose entries specify the number of points in an 8-connected neighborhood where a disparity estimate is available. An example of such a structure is depicted in FIG. 9.

Once the initialization stage is completed, the disparity information available is propagated starting from the denser neighborhoods. Two types of constraints are enforced during the disparity propagation. The first type of constraint ensures that the order of appearance of a set of image features along the x direction is preserved. This condition, even though it is not always satisfied, is generally true in most situations where the camera's base distance is sufficiently small. An example of allowed and prohibited orders of appearance of image elements is depicted in FIG. 10. This consistency requirement translates in the following set of hard constraints on the minimum and maximum value of the disparity in a given block i:

$$\begin{matrix}{d}_{min}^{( i )} = {d}^{( i - 1 )} - ɛ and \\ {d}_{max}^{( i )} = {d}^{( i + 1 )} + ɛ , where \\ {d}_{max}^{( i )} = {d}^{( i + 1 )} + ɛ \\ ɛ = \vert {x}_{i} - {x}_{i - 1} \vert\end{matrix}$$

This type of constraint is very useful for avoiding false matches of regions with similar features.

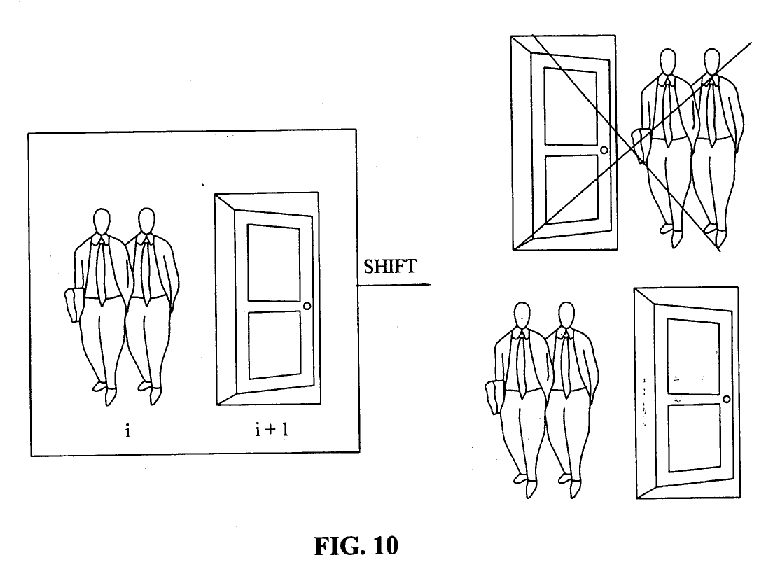

The local smoothness of the disparity map is enforced by the second type of propagation constraint. An example of a 3×3 neighborhood where the disparity of the central element has to be estimated is shown in FIG. 11. In this example, the local smoothness constraints are:
dₘᵢₙ=min{d∈Nᵢⱼ}−η, and
dₘₐₓ=max{d∈Nᵢⱼ}+η, where
Nᵢⱼ={P_{m,n}}, m=i−1, . . . , i+1, and n=j−1, . . . , j+1.

The concept is that very large local fluctuations of the disparity estimates are more often due to matching errors than to true sharp variations. As a consequence, enforcing a certain degree of smoothness in the disparity map greatly improves the signal-to-noise ratio of the estimates. In one embodiment, the parameter η is forced equal to zero, thus bounding the search interval of possible disparities between the minimum and maximum disparity currently measured in the neighborhood.

Additional constraints to the disparity value propagation based on the local statistics of the grayscale image are enforced. This feature attempts to lower the amount of artifacts due to poor illumination conditions and poorly textured areas of the image, and addresses the issue of propagation of disparity values across object boundaries. In an effort to reduce the artifacts across the boundaries between highly textured objects and poorly textured objects, some local statistics of the regions of interest used to perform the disparity estimation are computed. This is done for the entire frame, during the initialization stage of the algorithm. The iterative propagation technique takes advantage of the computed statistics to enforce an additional constraint to the estimation process. The results obtained by applying the algorithm to several sample images have produced a net improvement in the disparity map quality in the proximity of object boundaries and a sharp reduction in the amount of artifacts present in the disparity map.

Because the disparity estimation is carried on in an iterative fashion, the mismatch value for a particular image block and a particular disparity value usually need to be evaluated several times. The brute force computation of such cost function every time its evaluation is required is computationally inefficient. For this reason, an ad-hoc caching technique may be used in order to greatly reduce the system time-response and provide a considerable increase in the speed of the estimation process. The quantity that is stored in the cache is the mismatch measure for a given disparity value in a particular point of the disparity grid. In a series of simulations, the number of hits in the cache averaged over 80%, demonstrating the usefulness of the technique.

The last component of the Disparity Map module 302 is an automatic vertical calibration subroutine. This functionality is particularly useful for compensating for hardware calibration tolerances. While an undetected horizontal offset between the two cameras usually causes only limited errors in the disparity evaluation, the presence of even a small vertical offset can be catastrophic. The rapid performance degradation of the matching algorithm when such an offset is present is a very well-known problem that affects all stereo camera-based ranging systems.

A fully automated vertical calibration subroutine is based on the principle that the number of correctly matched image features during the initialization stage is maximized when there is no vertical offset between the left and right image. The algorithm is periodically run during and after system initialization in order to check for the consistency of the estimate.

(b) System Performance

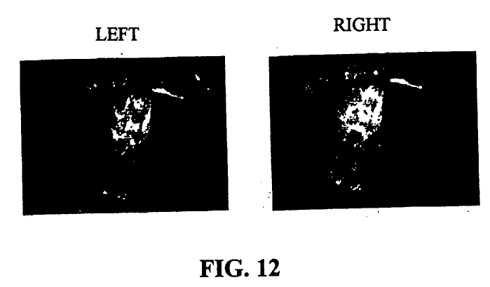

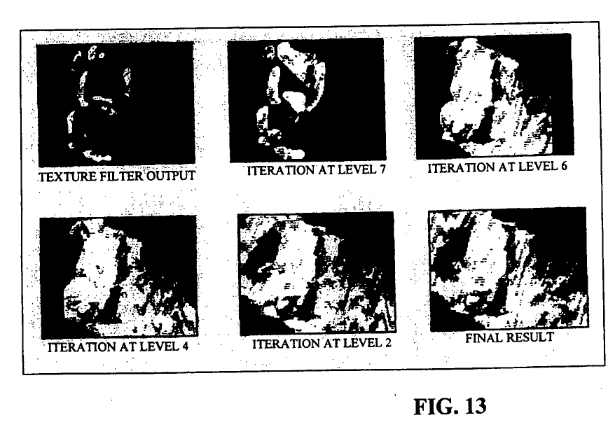

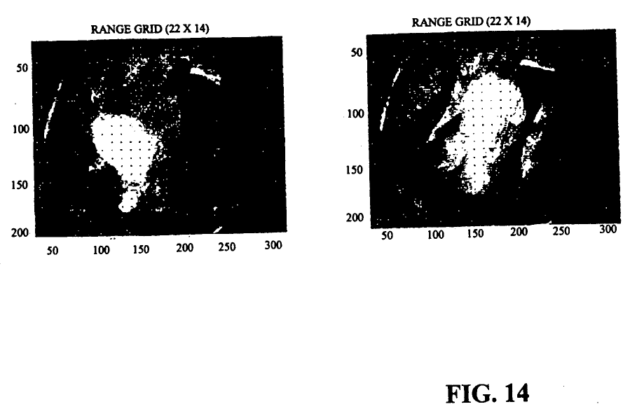

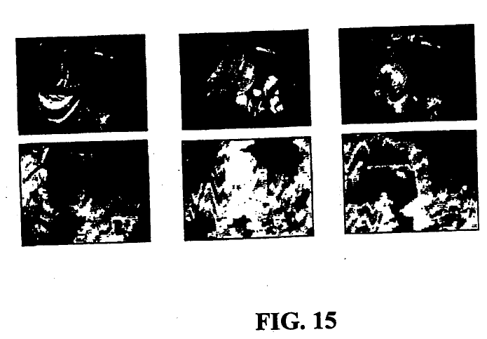

An example of a stereo image pair is shown in FIG. 12, and its corresponding computed disparity map at several iteration levels is shown in FIG. 13. In order to maximize the classification performance of the system, the grid over which the disparity values are estimated is tailored around the region where the seat occupant is most likely to be present. An example of an actual occupant with the disparity grid superimposed is depicted in FIG. 14. An accurate selection of the points used to estimate the disparity profile, in fact, resulted in highly improved sensitivity and specificity of the system. Several examples of disparity maps obtained for different types of occupants are depicted in FIG. 15.

(7) Processing

Each of the three classification modules 314, 316, and 318 produces class confidences for specified occupant types. The class confidences produced by each individual module can be processed by processor 326 to produce an estimate of the presence of a particular type of occupant or to produce an occupant-related decision, such as airbag enable or disable. More particularly, processor 326 can perform a mathematical function on the class confidences produced by classification modules 314, 316, and 318 to produce an airbag enable/disable decision. For example, processor 326 can compute an average of the class confidences produced by classification modules 314, 316, and 318. Such an average is likely to be more useful in making an accurate airbag enable/disable decision than the class confidences produced by any one of classification modules 314, 316, and 318 alone.

(8) Classification Algorithms

In this section, a non-limiting set of classification algorithms that may be used for classification of the extracted feature data sets are discussed.

a. Feedforward Backpropagation Neural Network

It has been found that a standard fully-interconnected, feedforward backpropagation neural network (FBNN) with carefully chosen control parameters provides superior performance. A feedforward backpropagation neural network generally consists of multiple layers, including an input layer, one or more hidden layers, and an output layer. Each layer consists of a varying number of individual neurons, where each neuron in any layer is connected to every neuron in the succeeding layer. Associated with each neuron is a function which is variously called an activation function or a transfer function. For a neuron in any layer but the output layer, this function is a nonlinear function which serves to limit the output of the neuron to a narrow range (typically 0 to 1 or −1 to 1). The function associated with a neuron in the output layer may be a nonlinear function of the type just described, or a linear function which allows the neuron to produce all values.

In a backpropagation network, there are three steps that occur during training. In the first step, a specific set of inputs are applied to the input layer, and the outputs from the activated neurons are propagated forward to the output layer. In the second step, the error at the output layer is calculated and a gradient descent method is used to propagate this error backward to each neuron in each of the hidden layers. In the final step, the backpropagated errors are used to recompute the weights associated with the network connections.

b. Nonlinear Discriminant Analysis (NDA)

The NDA algorithm is based on the well-known back-propagation algorithm. It consists of an input layer, two hidden layers, and an output layer. The second hidden layer is deliberately constrained to have either two or three hidden nodes with the goal of visualizing the decision making capacity of the neural network. The two (or three) hidden layer nodes of the second hidden layer can be viewed as latent variables of a two (or three) dimensional space which are obtained by performing a nonlinear transformation (or projection) of the input space onto the latent variable space. In reduction to practice, it has been observed that the second hidden layer did not enhance the accuracy of the results. Thus, in some cases, it may be desirable to resort to a single hidden layer network. While this modification removes the ability to visualize the network, it may still be interpreted by expressing it as a set of equivalent fuzzy If-Then rules. Furthermore, use of a single hidden layer network offers the advantage of reduced computational cost. The network architecture used in this case was fixed at one hidden layer with 25 nodes. There were five output nodes (RFIS, FFIS, Adult_nt, OOP, and Empty). The network was trained on each of the three data types using a training set and was then tested using a validation data set. For the enable/disable case (where FFIS, Adult in normal position constitute enable scenarios and the rest of the classifications constitute disable scenarios), the NDA performed at around 97%.

c. M-Probart

The M-PROBART (the Modified Probability Adaptive Resonance Theory) neural network algorithm is a variant of the Fuzzy ARTMAP. This algorithm was developed to overcome the deficiency in Fuzzy ARTMAP of on-line approximation of nonlinear functions under noisy conditions. When used in conjunction with the present invention, a variant of the M-PROBART algorithm that is capable of learning with high accuracy but with a minimal number of rules may be used.

The key difference between the NDA and the M-PROBART is that the latter offers the possibility of learning in an on-line fashion. In the reduction to practice of one embodiment, the M-PROBART was trained on the same dataset as the NDS. The M-PROBART was able to classify the prediction set with accuracy comparable to NDA. In contrast to the NDA, the M-PROBART required many more rules. In particular, for the set of wavelet features which contains roughly double the number of features as compared to edge density and disparity, the M-PROBART required a very large number of rules. The rule to accuracy ratio for NDA is therefore superior to the M-PROBART. However, if the training is to be performed in an on-line fashion, the M-PROBART is the only classifier among these that can do so.

d. C5 Decision Trees and Support Vector Machine

In reduction to practice of an embodiment of the present invention, C5 decision trees and support vector machine (SVM) algorithms have also been applied. Decision tree methods are well known in the art. These methods, such as C5, its predecessor C4.5 and others, generate decision rules which separate the feature vectors into classes. The rules are of the form IF F1<T1 AND F2>T2 AND . . . THEN CLASS=RFIS, where the F's are feature values and T's are threshold parameter values. The rules are extracted from a binary decision tree which is formed by selecting a test which divides the input set into two subsets where each subset contains a larger proportion of a particular class than the predecessor set. Tests are then selected for each subset in an inductive manner, which results in the binary decision tree. Each decision tree algorithm uses a different approach to selecting the tests. C5, for example, uses entropy and information gain to select a test. Eventually each subset will contain only members of a particular class, at which point the subset forms the termination or leaf of that branch of the tree. The tests are selected so as to maximize the probability that each leaf will contain as many cases as possible. This will both reduce the size of the tree and maximize the generalization power.

While C5 provides adequate performance and can be efficiently implemented, FBNN, NDA and M-PROBART were found to offer superior performance. The SVM approach, however, is expected to be very promising, appearing to be slightly less than NDA in performance. However, SVM is also more difficult to use because it is formulated for the 2-class problem. The classifiers used with the embodiment of the present invention, as reduced to practice in this case, make 5-class decisions, which require the use of a system of 2-class SVM “experts” to implement 5-class classification. Similar modifications would be required for decisions involving over 2-class classifications.

(9) Other Embodiments

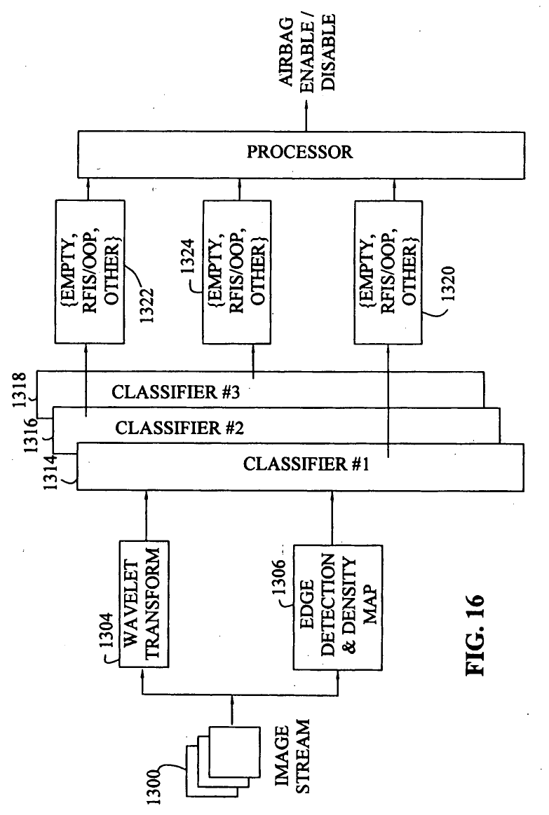

Another embodiment of an object detection and tracking system of the present invention is shown in FIG. 16. The embodiment of FIG. 3 discussed above uses two cameras to provide stereo image data. The lower cost alternative embodiment of FIG. 16, in contrast, uses a single camera to produce image stream 1300. Another difference is that no disparity map module is utilized in the embodiment of FIG. 16. Only a Wavelet Transform module 1304 and an Edge Map module 1306 are used, which are substantially similar to Wavelet Transform module 304 and Edge Detection and Density Map 306, respectively, of FIG. 3. Yet another difference is that there are only three possible categories (empty, rfis/oop, other) of the output of classifiers 1314, 1316, 1318, as represented by class prediction and confidence values 1320, 1322, 1324. Other aspects of the system of FIG. 16 are substantially similar to those of the system of FIG. 3, and thus are not discussed in detail herein.

Other embodiments of the present invention for use in vehicle occupant detection and tracking may be adapted to provide other classifications of vehicle occupants, such as small adult, small child, pet, etc. With the present invention, provision of additional classifications should have little impact on computation complexity and, therefore, update rates, since the classification processing is based upon rules determined by off-line training as described above. The additional classifications can then also be used to make an airbag deployment decision.

An exemplary embodiment of the present invention has been discussed in terms of providing a deployment decision to an airbag deployment system, but the apparatus and method of the present invention may also be used to control other features in an airbag deployment system or used to control other systems within a vehicle. For example, alternative embodiments of the present invention may provide decisions as to the strength at which the airbags are to be deployed, or decisions as to which airbags within a vehicle are to be deployed. Also, embodiments of the present invention may provide decisions for controls over seat belt tightening, seat position, air flow from a vehicle temperature control system, etc.

Other embodiments of the present invention may also be applied to other broad application areas such as Surveillance and Event Modeling. In the surveillance area, the present invention provides detection and tracking of people/objects within sensitive/restricted areas (such as embassies, pilot cabins of airplanes, driver cabins of trucks, trains, parking lots, etc.), where one or more cameras provide images of the area under surveillance. In such an embodiment, the classification modules would be trained to detect humans (may feasibly be trained even to detect particular individuals) within the viewing area of one or more cameras using the information extracted by the modules. The classification decisions from these modules can then be processed to provide the final decision as to the detection of a human within the surveillance area.

In the case of event modeling, other embodiments of the present invention would track the detected human across multiple images and identify the type of action being performed. It may be important for a given application that the human not walk in a certain direction or run, etc. within a restricted area. In order to perform event modeling, an additional motion signature module would first extract motion signatures from the detected humans. These motion signature would be learned using a classification algorithm such as a feedforward backpropagation neural network algorithm, NDA or C5 and would eventually be used to detect events of interest.

From the foregoing description, it will be apparent that the present invention has a number of advantages, some of which have been described above, and others of which are inherent in the embodiments of the invention described above. For example, other classification techniques may be used to classify the status of an object. Also, it will be understood that modifications can be made to the object detection system described above without departing from the teachings of subject matter described herein. As such, the invention is not to be limited to the described embodiments except as required by the appended claims.

1. A method of object detection comprising the steps of:
receiving images of an area occupied by at least one object;
extracting image features including wavelet features from the images; and
performing classification on the image features as a group in at least one common classification algorithm to produce object class confidence data.

2. The method of claim 1, wherein the object class confidence data includes a detected object estimate.

3. The method of claim 2, wherein the at least one object comprises a vehicle occupant and the area comprises a vehicle occupancy area, and further comprising a step of processing the detected object estimate to provide signals to vehicle systems.

4. The method of claim 3, wherein the signals comprise airbag enable and disable signals.

5. The method of claim 4, wherein the method further comprises a step of capturing images from a sensor selected from a group consisting of CMOS vision sensors and CCD vision sensors.

6. The method of claim 1, wherein the at least one common classification algorithm comprises a plurality of common classification algorithms.

7. The method of claim 6, comprising the further step of performing a mathematical function on the object class confidence data from each of the common classification algorithms to thereby arrive at a detected object estimate.

8. The method of claim 6, comprising the further step of averaging the object class confidence data from each of the common classification algorithms to thereby arrive at a detected object estimate.

9. The method of claim 6, wherein each of the common classification algorithms has at least one different parameter value.

10. The method of claim 1, wherein said at least one common classification algorithm is selected from the group consisting of a Feedforward Backpropagation Neural Network, a trained C5decision tree, a trained Nonlinear Discriminant Analysis network, and a trained Fuzzy Aggregation Network.

11. The method of claim 1, wherein the step of extracting image features comprises the step of extracting wavelet coefficients of the images of the at least one object occupying an area; and wherein the step of classifying the image features comprises processing the wavelet coefficients with said at least one common classification algorithm.

12. The method of claim 1, wherein the step of extracting image features further comprises the steps of:
detecting edges of the at least one object within the images;
masking the edges with a background mask to find important edges;
calculating edge pixels from the important edges; and
producing edge density maps from the important edges, the edge density map providing the image features, and wherein the step of classifying the image features comprises processing the edge density map with the at least one common classification algorithm.

13. The method of claim 1, wherein the step of extracting image features further comprises the steps of:
receiving a stereoscopic pair of images of an area occupied by at least one object;
detecting pattern regions and non-pattern regions within each of the pair of images using a texture filter;
generating an initial estimate of spatial disparities between the pattern regions within each of the pair of images;
using the initial estimate to generate a subsequent estimate of the spatial disparities between the non-pattern regions based on the spatial disparities between the pattern regions using disparity constraints;
iteratively using the subsequent estimate as the initial estimate in the step of using the initial estimate to generate a subsequent estimate in order to generate further subsequent estimates of the spatial disparities between the non-pattern regions based on the spatial disparities between the pattern regions using the disparity constraints until there is no change between the results of subsequent iterations, thereby generating a final estimate of the spatial disparities; and
generating a disparity map of the area occupied by at least one object from the final estimate of the spatial disparities, and wherein the step of performing classification on the image features comprises processing the disparity map with the at least one classification algorithm to produce object class confidence data.

14. The method of claim 1, further comprising the steps of:
detecting motion of the at least one object within the images;
calculating motion pixels from the motion; and
producing motion density maps from the motion pixels, the motion density map providing the image features; and wherein the step of classifying the image features comprises processing the motion density map with the at least one classification algorithm to produce object class confidence data.

15. The method of claim 1, wherein the receiving step comprises receiving a stereoscopic pair of images of an area occupied by at least one object, the extracting step including extracting image features from the images, with at least a portion of the image features being extracted by the steps of:
detecting pattern regions and non-pattern regions within each of the pair of images using a texture filter;
generating an initial estimate of spatial disparities between the pattern regions within each of the pair of images;
using the initial estimate to generate a subsequent estimate of the spatial disparities between the non-pattern regions based on the spatial disparities between the pattern regions using disparity constraints;
iteratively using the subsequent estimate as the initial estimate in the step of using the initial estimate to generate a subsequent estimate in order to generate further subsequent estimates of the spatial disparities between the non-pattern regions based on the spatial disparities between the pattern regions using the disparity constraints until there is no change between the results of subsequent iterations, thereby generating a final estimate of the spatial disparities; and
generating a disparity map of the area occupied by at least one object from the final estimate of the spatial disparities.

16. A computer program product for object detection, the computer program product comprising means, stored on a computer readable medium, for:
receiving images of an area occupied by at least one object;
extracting image features including wavelet features from the images; and
performing classification on the image features as a group in at least one common classification algorithm to produce object class confidence data.

17. A computer program product for object detection as set forth in claim 16, wherein the means for performing classification on the image features as a group comprises a means for processing the image features with at least one classification algorithm, said at least one common classification algorithm being selected from the group consisting of a Feedforward Backpropagation Neural Network, a trained C5 decision tree, a trained Nonlinear Discriminant Analysis network, and a trained Fuzzy Aggregation Network.

18. A computer program product for object detection as set forth in claim 16, wherein the means for extracting image features comprises a means for extracting wavelet coefficients of the at least one object in the images, and wherein the means for classifying the image features comprises a means for processing the wavelet coefficients with the at least one classification algorithm, at least one of the classification algorithms being selected from the group consisting of a Feedforward Backpropagation Neural Network, a trained C5 decision tree, a trained Nonlinear Discriminant Analysis network, and a trained Fuzzy Aggregation Network.

19. A computer program product for object detection as set forth in claim 18, wherein the means for extracting image features further comprises means for:
detecting edges of the at least one object within the images;
masking the edges with a background mask to find important edges;
calculating edge pixels from the important edges; and
producing edge density maps from the important edges, the edge density map providing the image features, and wherein the means for classifying the image features processes the edge density map with the at least one classification algorithm to produce object class confidence data.

20. A computer program product for object detection as set forth in claim 19, wherein the means for extracting image features further comprises means for:
receiving a stereoscopic pair of images of an area occupied by at least one object;
detecting pattern regions and non-pattern regions within each of the pair of images using a texture filter;
generating an initial estimate of spatial disparities between the pattern regions within each of the pair of images;
using the initial estimate to generate a subsequent estimate of the spatial disparities between the non-pattern regions based on the spatial disparities between the pattern regions using disparity constraints;
iteratively using the subsequent estimate as the initial estimate in the means for using the initial estimate to generate a subsequent estimate in order to generate further subsequent estimates of the spatial disparities between the non-pattern regions based on the spatial disparities between the pattern regions using the disparity constraints until there is no change between the results of subsequent iterations, thereby generating a final estimate of the spatial disparities; and
generating a disparity map of the area occupied by at least one object from the final estimate of the spatial disparities, and wherein the means for classifying the image features processes the disparity map with the at least one classification algorithm to produce object class confidence data.

21. An apparatus for object detection comprising a computer system including a processor, a memory coupled with the processor, an input coupled with the processor for receiving images, and an output coupled with the processor for outputting information based on an object estimation, wherein the computer system further comprises means, residing in its processor and memory, for:
receiving images of an area occupied by at least one object;
extracting image features including wavelet features from the images; and
performing classification on the image features as a group in at least one common classification algorithm to produce object class confidence data.

22. An apparatus for object detection as set forth in claim 21, wherein the means for classifying image features comprises a means for processing the image features with the at least one classification algorithm, the at least one classification algorithm being selected from the group consisting of a Feedforward Backpropagation Neural Network, a trained C5 decision tree, a trained Nonlinear Discriminant Analysis network, and a trained Fuzzy Aggregation Network.

23. An apparatus for object detection as set forth in claim 21, wherein means for extracting image features comprises a means for:
extracting wavelet coefficients of the at least one object in the images; and
wherein the means for classifying the image features comprises processing the wavelet coefficients with the at least one classification algorithm to produce object class confidence data, the at least one classification algorithm being selected from the group consisting of a Feedforward Backpropagation Neural Network, a trained C5 decision tree, a trained Nonlinear Discriminant Analysis network, and a trained Fuzzy Aggregation Network.

24. An apparatus for object detection as set forth in claim 23, wherein the means for extracting image features further comprises means for:
detecting edges of the at least one object within the images;
masking the edges with a background mask to find important edges;
calculating edge pixels from the important edges; and
producing edge density maps from the important edges, the edge density map providing the image features;
wherein the means for classifying the image features processes the edge density map with at least one of the classification algorithms to produce object class confidence data; and
wherein the means for extracting image features further comprises means for:
receiving a stereoscopic pair of images of an area occupied by at least one object;
detecting pattern regions and non-pattern regions within each of the pair of images using a texture filter;
generating an initial estimate of spatial disparities between the pattern regions within each of the pair of images;
using the initial estimate to generate a subsequent estimate of the spatial disparities between the non-pattern regions based on the spatial disparities between the pattern regions using disparity constraints;
iteratively using the subsequent estimate as the initial estimate in the means for using the initial estimate to generate a subsequent estimate in order to generate further subsequent estimates of the spatial disparities between the non-pattern regions based on the spatial disparities between the pattern regions using the disparity constraints until there is no change between the results of subsequent iterations, thereby generating a final estimate of the spatial disparities; and
generating a disparity map of the area occupied by at least one object from the final estimate of the spatial disparities, and wherein the means for classifying the image features processes the disparity map with the at least one classification algorithm to produce object class confidence data.

25. An apparatus for object detection as set forth in claim 23, wherein the means for extracting image features further comprises means for:
receiving a stereoscopic pair of images of an area occupied by at least one object;
detecting pattern regions and non-pattern regions within each of the pair of images using a texture filter;
generating an initial estimate of spatial disparities between the pattern regions within each of the pair of images;
using the initial estimate to generate a subsequent estimate of the spatial disparities between the non-pattern regions based on the spatial disparities between the pattern regions using disparity constraints;
iteratively using the subsequent estimate as the initial estimate in the means for using the initial estimate to generate a subsequent estimate in order to generate further subsequent estimates of the spatial disparities between the non-pattern regions based on the spatial disparities between the pattern regions using the disparity constraints until there is no change between the results of subsequent iterations, thereby generating a final estimate of the spatial disparities; and
generating a disparity map of the area occupied by at least one object from the final estimate of the spatial disparities, and wherein the means for classifying the image features processes the disparity map with the at least one classification algorithm to produce object class confidence data.

26. An apparatus for object detection as set forth in claim 21, wherein the computer system further comprises means, residing in its processor and memory, for:
receiving a stereoscopic pair of images of an area occupied by at least one object;
extracting image features from the images, with at least a portion of the image features being extracted by means for:
detecting pattern regions and non-pattern regions within each of the pair of images using a texture filter;
generating an initial estimate of spatial disparities between the pattern regions within each of the pair of images,;
using the initial estimate to generate a subsequent estimate of the spatial disparities between the non-pattern regions based on the spatial disparities between the pattern regions using disparity constraints;
iteratively using the subsequent estimate as the initial estimate in the means for using the initial estimate to generate a subsequent estimate in order to generate further subsequent estimates of the spatial disparities between the non-pattern regions based on the spatial disparities between the pattern regions using the disparity constraints until there is no change between the results of subsequent iterations, thereby generating a final estimate of the spatial disparities; and
generating a disparity map of the area occupied by at least one object from the final estimate of the spatial disparities; and
performing classification on the image features as a group in at least one common classification algorithm to produce object class confidence data, with at least a portion of the classifying being performed by processing the disparity map with the at least one classification algorithm to produce object class confidence data.
